(19) United States
(12) Patent Application Publication
(10) Pub. No.: US 2023/0004812 A1
(43) Pub. Date: Jan. 5, 2023

(54) HIERARCHICAL SUPERVISED TRAINING FOR NEURAL NETWORKS

(71) Applicant: QUALCOMM Incorporated, San Diego, CA (US)

(72) Inventors: Shubhankar Mangesh BORSE, San Diego, CA (US); Hong CAI, San Diego, CA (US); Yizhe ZHANG, San Diego, CA (US); Fatih Murat PORIKLI, San Diego, CA (US)

(21) Appl. No.: 17/808,949

(22) Filed: Jun. 24, 2022

Related U.S. Application Data
(60) Provisional application No. 63/214,940, filed on Jun. 25, 2021.

(51) Int. Cl. G06N 3/08; G06K 9/62

(52) U.S. Cl. CPC G06N 3/082; G06K 9/6218; G06K 9/628

(57) ABSTRACT

Certain aspects of the present disclosure provide techniques for training neural networks using hierarchical supervision. An example method generally includes training a neural network with a plurality of stages using a training data set and an initial number of classification clusters into which data in the training data set can be classified. A cluster-validation set performance metric is generated for each stage based on a reduced number of classification clusters relative to the initial number of classification clusters and a validation data set. A number of classification clusters to implement at each stage is selected based on the cluster-validation set performance metric and an angle selected relative to the cluster-validation set performance metric for a last stage of the neural network. The neural network is retrained based on the training data set and the selected number of classification clusters for each stage, and the trained neural network is deployed.

### CROSS-REFERENCE TO RELATED APPLICATIONS

This application claims the benefit of and priority to U.S. Provisional Patent Application Ser. No. 63/214,940, entitled “Hierarchical Supervised Training for Neural Networks,” filed Jun. 25, 2021, and assigned to the assignee hereof, the contents of which are hereby incorporated by reference in its entirety.

### INTRODUCTION

Aspects of the present disclosure relate to machine learning.

Some applications of machine learning may involve the use of neural networks to classify input data. These neural networks may be used, for example, in various scenarios where semantic information about the data to be classified may be used in the classification process, such as in semantic segmentation of data (e.g., for data compression), augmented reality or virtual reality, in controlling autonomous vehicles, in operations based on domain-specific data (e.g., medical imaging), or the like. Generally, semantic segmentation attempts to classify (or assign a label) to each of a plurality of subcomponents in data input into a neural network for classification. For example, a neural network used to classify different segments of an image can assign one of a plurality of labels to each pixel of the image so that different regions of the image may be correlated to different categories of data.

In some examples, deep neural networks may be trained and deployed to perform various classification tasks using semantic segmentation. A deep neural network generally includes an input layer, one or more intermediate layers, and an output layer which together attempts to perform various tasks, such as classifying an input into one of a plurality of categories, tracking objects across a spatial area, translation, prediction, and so on. However, supervised learning techniques used to train these deep neural networks may not accurately classify data for various reasons.

Accordingly, what is needed are improved techniques for training deep neural networks.

### BRIEF SUMMARY

Certain aspects provide a method for training a neural network. The method generally includes training a neural network with a plurality of stages using a training data set and an initial number of classification clusters into which data in the training data set can be classified. A cluster-validation set performance metric is generated for each stage of the plurality of stages of the neural network based on a reduced number of classification clusters relative to the initial number of classification clusters and a validation data set separate from the training data set. A number of classification clusters to implement at each stage of the plurality of stages of the neural network is selected based on the cluster-validation set performance metric and an angle selected relative to the cluster-validation set performance metric for a last stage of the neural network. The neural network is retrained based on the training data set and the selected number of classification clusters for each stage of the plurality of stages, and the trained neural network is deployed.

Other aspects provide a method for classifying data using a trained neural network. The method generally includes receiving an input for classification. The input is classified using a neural network having a plurality of stages. Generally, each stage of the plurality of stages classifies the input using a different number of classification clusters. One or more actions are taken based on the classification of the input.

Other aspects provide processing systems configured to perform the aforementioned methods as well as those described herein; non-transitory, computer-readable media comprising instructions that, when executed by one or more processors of a processing system, cause the processing system to perform the aforementioned methods as well as those described herein; a computer program product embodied on a computer readable storage medium comprising code for performing the aforementioned methods as well as those further described herein; and a processing system comprising means for performing the aforementioned methods as well as those further described herein.

The following description and the related drawings set forth in detail certain illustrative features of one or more embodiments.

### BRIEF DESCRIPTION OF THE DRAWINGS

The appended figures depict certain aspects of the one or more embodiments and are therefore not to be considered limiting of the scope of this disclosure.

FIG. 1 depicts an example architecture of a neural network used in generating an inference from a received input.

FIG. 2 illustrates example operations that may be performed by a computing system to train a neural network using hierarchical supervision, according to aspects of the present disclosure.

FIG. 3 illustrates example operations that may be performed by a computing device to classify data using a neural network trained using hierarchical supervision, according to aspects of the present disclosure.

FIG. 4 illustrates an example plot of cluster-validation set performance for each stage of a plurality of stages in a neural network as a function of a number of classification clusters in each stage in the neural network, according to aspects of the present disclosure.

FIG. 5 illustrates an example architecture of a neural network trained using hierarchical supervision, according to aspects of the present disclosure.

FIG. 6 illustrates an example architecture of a neural network trained using hierarchical supervision including segmentation transformers associated with each stage of the neural network, according to aspects of the present disclosure.

FIG. 7 illustrates an example implementation of a processing system in which a neural network can be trained using hierarchical supervision, according to aspects of the present disclosure.

FIG. 8 illustrates an example implementation of a processing system in which data can be classified using a neural network trained using hierarchical supervision, according to aspects of the present disclosure.

To facilitate understanding, identical reference numerals have been used, where possible, to designate identical elements that are common to the drawings. It is contemplated that elements and features of one embodiment may be beneficially incorporated in other embodiments without further recitation.

### DETAILED DESCRIPTION

Aspects of the present disclosure provide apparatuses, methods, processing systems, and computer-readable mediums for training neural networks using hierarchical supervision and varying numbers of classification clusters at each stage of the neural network.

Neural networks used in various data classification tasks generally include a number of stages, or layers, which may perform discrete classification tasks in order to classify data input into these neural networks. These neural networks may include encoder-decoder architectures in which an encoder encodes an input into a latent space (or otherwise compressed) representation of the input, a decoder generates a reconstruction of the input, and a classification task is performed based on the latent space representation of the input. These neural networks may also include multi-stage neural networks in which each stage of the neural network is configured to perform task with respect to the input.

### Example Neural Network Architecture

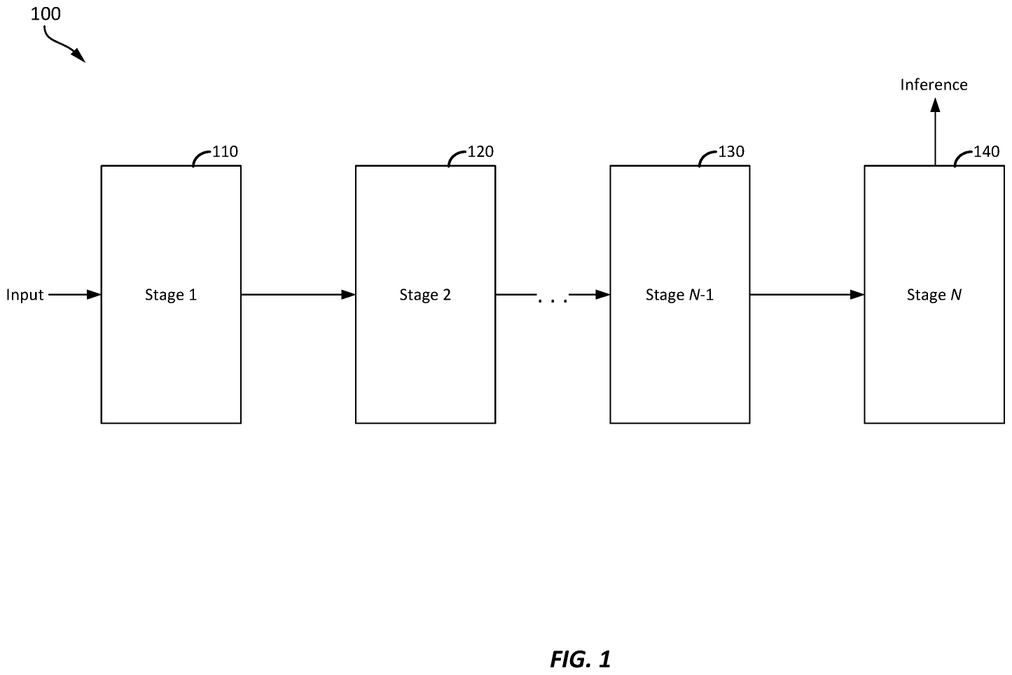

FIG. 1 illustrates an architecture of a neural network used in generating an inference from a received input. Generally, the neural network 100 may include any number N of stages through which an input, or data derived by a stage from the input, is processed in order to generate an inference as the output of the neural network 100. As illustrated, the neural network 100 includes a plurality of stages 110, 120, 130, and 140, designated as Stage 1, Stage 2, Stage N−1, and Stage N, respectively. To generate an inference with respect to an input—for example, to classify the input, or portions thereof, into one of a plurality of categories—the input may be fed into Stage 1 110. The output of Stage 1 110 (e.g., a feature map) may serve as input into Stage 2 120. More generally, for any stage after an initial stage of the neural network 100 (e.g., for stages 120, 130, and 140, as illustrated in FIG. 1), the input for that stage generally includes the output of a previous stage. The output of Stage 140 (e.g., the N^{th} and final stage of the neural network 100) may be the inference generated for the input. Though not depicted, in various embodiments, “skip” connections (also known as residual or shortcut connections) may also be used in neural network 100 to skip over certain stages, or to accumulate a stage's output with its input, to name just a few examples.

Neural network 100 may be affected by various complications that result in degraded accuracy of the output of these neural networks. As neural networks become deeper (e.g., as neural networks include more intermediate stages between an input stage and an output stage), neural networks may be increasingly affected by the vanishing gradient problem. The vanishing gradient problem generally refers to a situation arising when, in optimizing a loss function at each stage of the neural network, the gradient of the loss function approaches zero. Thus, in neural networks affected by the vanishing gradient problem, the weights and biases at each stage of the neural network may not be updated effectively, and the resulting neural network may not be able to make accurate inferences against input data. In another example, intermediate stages in these neural networks may not be able to identify sensible patterns in an input that would allow for an accurate output to be generated by the neural network for a given input.

To address the vanishing gradient problem and the inability of intermediate stages in neural networks to identify sensible patterns in an input, and thus to improve the accuracy of neural networks, direct supervision of intermediate stages in the neural network has been proposed. In directly supervising the training of each intermediate stage in the neural network 100 (e.g., stages 2 through N−1 illustrated in FIG. 1), intermediate stages may be trained using auxiliary loss functions that add a loss term and attempts to mitigate the vanishing gradient problem that deep neural networks can experience. Each intermediate stage may also be trained based on ground truth data, such as ground truth maps representing a desired classification for different portions of an input image. However, because intermediate stages of a neural network may have limited abilities to accurately classify data (e.g., have weaker representation power than the final stage of the neural network), these intermediate stages may also be unable to identify coherent patterns from the input data and the ground truth maps, thus adversely affecting the accuracy of inferences generated by the neural network. Further, in training the intermediate stages in the neural network, differences in the representation power of the intermediate stages and the final stage may be disregarded.

### Example Methods for Training Neural Networks Using Hierarchical Supervision

To improve the accuracy of deep neural networks, aspects of the present disclosure describe techniques by which neural networks can be trained using hierarchical supervision. In using hierarchical supervision to train a neural network, intermediate stages of the neural network may be trained using a reduced number of classification clusters relative to the number of classification clusters into which data can be classified at the final stage of the neural network. Generally, a classification cluster may represent a class into which data can be classified. As discussed in further detail herein, the classification clusters may be used to classify data on a more granular basis at later stages in the neural network and on a more generalized basis at earlier stages in the neural network. By doing so, aspects of the present disclosure may simplify training of intermediate stages of the neural network so that the intermediate stages of the neural network can be trained using fewer computing resources (e.g., processing power, processing time, memory, etc.) than would be used in training the neural network using direct supervision of the intermediate stages of the neural network in which each stage of the neural network is trained using the of classification clusters into which data can be classified at the final stage of the neural network. Further, aspects of the present disclosure may provide for neural networks that more accurately generate inferences for an input than neural networks in which the intermediate stages are trained using direct supervision.

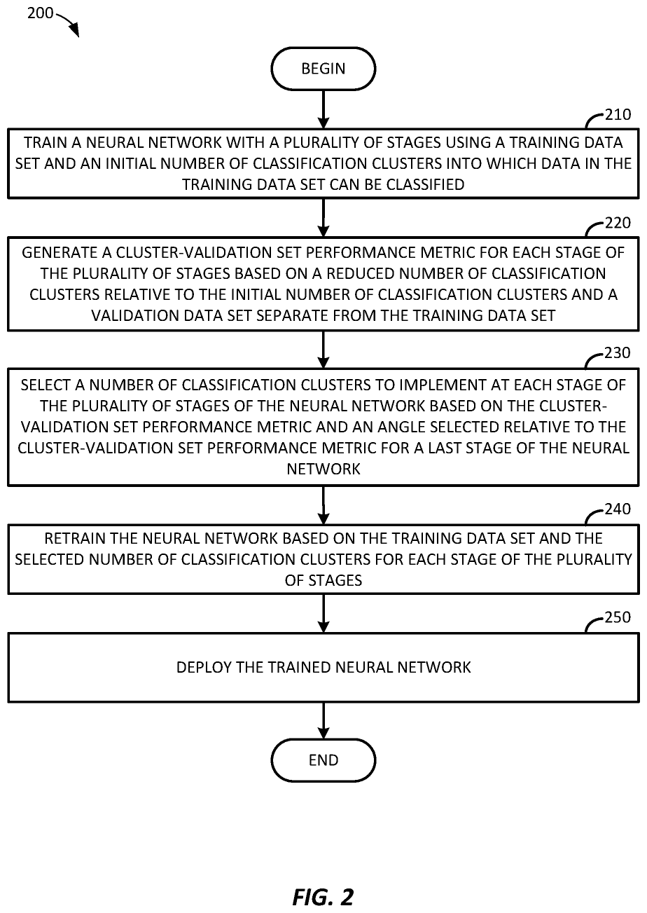

FIG. 2 illustrates example operations 200 that may be performed for training a neural network using hierarchical supervision, according to certain aspects of the present disclosure. Operations 200 may be performed, for example, by a physical or virtual computing device or cluster of physical and/or virtual computing devices on which neural networks can be trained.

As illustrated, operations 200 begin at block 210, where a neural network is trained. The neural network generally includes a plurality of stages. The neural network may be trained using a training data set and an initial number of classification clusters into which data in the training data set can be classified. Generally, training the neural network may include training a new neural network from a training data set, further training a partially trained model, or fine tuning an already trained model (e.g., by performing retraining, incremental training, training in a federated learning scheme, and the like).

Generally, the neural network may be trained using supervised learning techniques in which each element in the training data set is labeled with information identifying a category to which the element belongs. The training data set may be generated as a portion of a larger data set from which the training data set and a validation data set may be generated. Generally, the training data set may be significantly larger than the validation data set. For example, the training data set may be ninety percent of the overall data set, and the validation data set may be the remaining ten percent of the overall data set.

At block 220, a cluster-validation set performance metric is generated for each stage of the plurality of stages. The cluster-validation set performance metric may be based on a reduced number of classification clusters relative to the initial number of classification clusters and a validation data set separate from the training data set. Generally, reducing the number of classification clusters may result in classification clusters that encompass broader classes of data. By doing so, earlier stages in a neural network, which may have less robust abilities to classify data at a granular level, can be trained to classify data into broader classes. This may improve the performance of neural networks used in classifying data, such as by increasing the accuracy of predictions made using these neural networks and reducing compute resources used in training these neural networks.

In some aspects, the reduced number of classification clusters may be defined a priori. The set of classification clusters into which data in the training data set can be classified may include a number of specific species of classifications that can be grouped into an overall genus. For example, assume that the set of classification clusters includes the classifications “train,” “car,” “bus,” and “bicycle.” Based on human knowledge and an a priori defined reduction in the set of classification clusters, the classifications of “train,” “car,” “bus,” and “bicycle” may be consolidated into a single cluster representing, for example, wheeled transportation devices as an overall group, or the like.

In some aspects, the reduced number of classification clusters may be generated using agglomerative clustering techniques. As discussed above, at block 210, the neural network may be trained using direct supervision on the training data set. Two confusion matrices can be generated using the trained neural network: a first confusion matrix, Cₒᵤₜ^{T} calculated for the training data set and a second confusion matrix Cₒᵤₜ calculated for the validation data set. Generally, the confusion matrices identifies, for each class in the set of classification clusters into which data can be classified, a number of true positive predictions, a number of false positive predictions, and a number of false negative predictions. Subsequently, an adjacency matrix Aₒᵤₜ can be calculated over the set of classification clusters according to the equation:

$${A}_{o u t} = \frac{{C}_{out} + {C}_{out}^{T}}{‖ {C}_{out} + {C}_{out}^{T} ‖} \qquad ( 1 )$$

An adjacency matrix can be generated for each stage i through N of an N-stage neural network such that A_{out,i}∀i∈[1, N]. At each stage, agglomerative clustering can be used to combine clusters in the calculated adjacency matrix such that a plurality of neighboring clusters are reduced into a single cluster. This single cluster generally represents a broader classification of data than the classification associated with any one of the plurality of neighboring clusters that were consolidated into the single cluster.

In still another example, spectral clustering can be used to reduce the set of classification clusters into which data can be classified into a smaller set of classification clusters. Generally, spectral clustering allows for groups of classification clusters to be consolidated into a single larger group based on a graph representation and edges connecting nodes in the graph, where each classification cluster is represented by a node in the graph. To spectrally cluster classification clusters, the adjacency matrix for a given stage i, A_{out,i}, may be calculated according to Equation (1) above. One or more orthogonal eigenvectors can be identified within the adjacency matrix and clustered into a number of clusters. Data points within the adjacency matrix, representing different clusters in the set of classification clusters, may be consolidated into a single, broader, cluster based on determining that the data point is located in a row also assigned to a given cluster.

In still another example, each stage of the neural network may include a segmentation transformer module (also referred to as an object-contextual representation (OCR) module). Generally, a segmentation transformer module (or OCR module) characterizes data based on the relationship between the data and data in a surrounding region in an image, based on assumptions that a data point surrounded by data points of a given classification is likely to be similarly classified. In such an example, the segmentation transformer can extract a one-dimensional embedding for each classification cluster. Class-wise embeddings may be extracted by executing inferences on the validation data set, and k-means clustering may be applied to these embeddings in order to generate the reduced number of classification clusters.

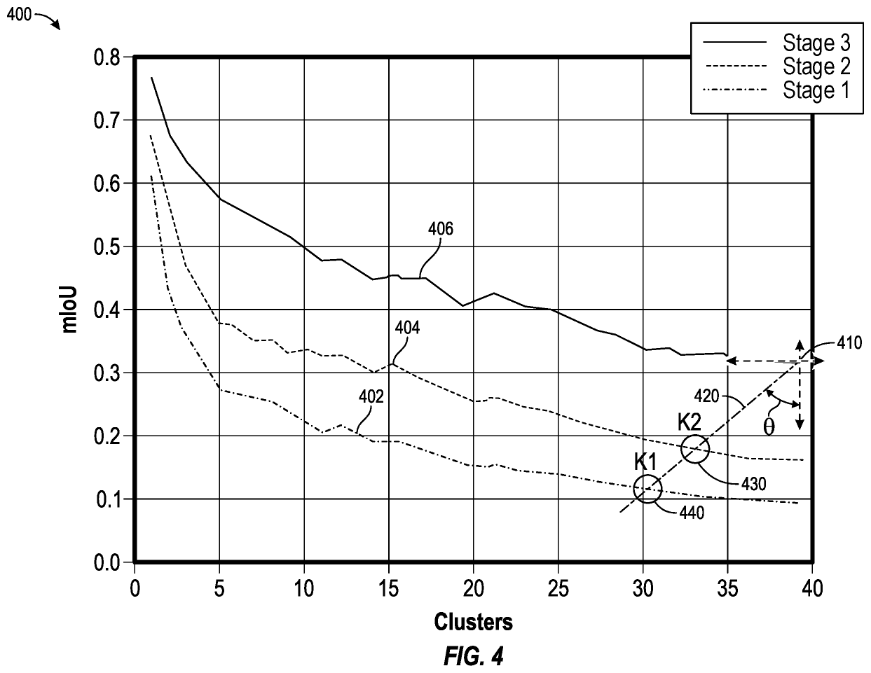

At block 230, a number of classification clusters to implement at each stage of the plurality of stages of the neural network is selected. The number of classification clusters may be selected based on the calculated cluster-validation set performance metric and an angle selected relative to the cluster-validation set performance metric for a last stage of the neural network, as discussed in further detail below and illustrated in FIG. 4.

In some aspects, to select the number of classification clusters to implement at each stage of the plurality of stages of the neural network, the generated cluster-validation set performance metric for each stage of the plurality of stages of the neural network can be plotted to show a relationship between inference performance and the number of clusters implemented at each stage of the plurality of stages. The generated cluster-validation set performance metric for the last stage of the neural network and the initial number of classification clusters may be selected as an origin point. From a vertical axis drawn from this origin point, an angle θ for a line drawn from the origin point may be selected to identify the number of classification clusters to implement at each intermediate stage of the neural network. In some aspects, the angle θ may range between 0° and 90°. A selected angle of θ=0° generally indicates that the neural network may be trained using direct supervision (e.g., using the same number of classification clusters), as each stage in the neural network may be trained using a same (or similar) number of classification clusters. A selected angle of θ=90° generally indicates that each stage in training should converge on a same or similar performance level (e.g., by using a number of classification clusters resulting in inference accuracy for any given stage being within a threshold amount of inference accuracy at the origin point). A selected angle θ between 0° and 90° may result in a progressive increase in the number of classification clusters used in each successive stage of the neural network. In some aspects, some angle between 0° and 90° may result in a highest inference performance (e.g., classification accuracy) for the neural network.

Generally, the selected angle θ may be used to identify the performance level of each stage in the neural network and the corresponding number of classification clusters to implement at each stage in the neural network. Various techniques can be used to identify the selected angle θ on the plot of the generated cluster-validation set performance metrics for each stage of the neural network. In one example, the selected angle θ may be selected based on a largest increase in performance between different stages in the neural network. In one example, a hyper-parameter search may be conducted to identify the angle θ resulting in a highest performance (e.g., accuracy) for the neural network. In some aspects, the angle may be selected such that successive stages in the neural network use increasing numbers of classification clusters relative to preceding stages in the neural network (e.g., the number of classification clusters monotonically increases as the layer number increases).

At 240, the neural network is retrained based on the training data set and the selected number of classification clusters for each stage of the plurality of stages.

In some aspects, the neural network may be retained using single-stage training or multi-stage training. In single-stage training, there may not be a priori knowledge of the capabilities of the neural network. To compensate, the selected number of classification clusters used in each stage may be defined a priori. For example, for a number of stages N in the neural network, the number of classification clusters at the i^{th} stage, where 1≤i≤N, may be defined as

$$\frac{1}{{2}^{N - i}} * TotalClassificationClusters .$$

In multi-stage training, the number of classification clusters for each stage may be selected using a plot and a selected angle θ relative to a defined origin point, as discussed above. At each stage, the classification clusters can be combined using various clustering techniques (as discussed above) so that the number of classification clusters equals a smaller number than the total number of classification clusters and equals the number of clusters at a point on the plot at which performance for the stage and a line drawn from the origin point using the selected angle θ intersect.

Generally, re-training the neural network may be performed by minimizing a loss function over each stage in the neural network. Where stage N represents the output stage of the neural network, and any given stage i has Kᵢ classification clusters (where Kᵢ represents a subset of the K classification clusters into which the neural network, the loss associated with the output stage N may be represented by the equation:

$${L}_{{K}_{N}} = \frac{{\sum }_{n = 0}^{{K}_{N} - 1} {L}_{n}}{{K}_{N}} \qquad ( 2 )$$

where Lₙ represents the binary loss term associated with a classification cluster n. The overall loss term, over the trained neural network, may be represented by the equation:

$${L}_{total} = {\sum }_{i = 1}^{N} {γ}_{i} {L}_{{K}_{i}} = {\sum }_{i = 1}^{N} {γ}_{i} \frac{{\sum }_{n = 0}^{{K}_{i} - 1} {L}_{n}}{{K}_{i}} \qquad ( 3 )$$

where γᵢ is the weight hyper-parameter associated with stage i of the neural network.

At block 250, the trained neural network is deployed. The neural network may be deployed to an endpoint device on which inferences can be performed locally, such as a mobile phone, a desktop or laptop computer, a vehicle user equipment (UE), or the like. In some aspects, the neural network may be deployed to a networked computing system (e.g., a server or cluster of servers). The networked computing system may be configured to receive, from a remote computing device, a request for an inference to be performed on a given input, use the neural network to generate the inference for the input, and output the inference to the remote computing device for the remote computing device to use in executing one or more actions on an application executing on the remote computing device.

In training a neural network using hierarchical supervision, a backbone network may be trained by imposing auxiliary supervision through segmentation heads attached to intermediate (or transitional) layers of the neural network. For a set of S ground truth predictions, a smaller set of semantic labels may be generated at each stage of the neural network, such that i, ∀i∈{1, . . . , N}, where i represents an intermediate stage in the neural network, and N<S. The resulting loss function may be represented by the equation

$${total}_{} = {\sum }_{i - 1}^{N} {γ}_{i} {i}_{{S}_{i}}^{} + {final}_{} \qquad ( 4 )$$

where [symbol] ᵢ^{S}^{ᵢ} is the segmentation loss for the i^{th} intermediate stage, γᵢ is the weight of the i^{th} intermediate stage, and [symbol] _{final} represents the segmentation loss at the final stage of the neural network. Unlike neural networks trained using the same set of classes at each stage of the neural network, aspects of the present disclosure train a neural network by supervising each intermediate layer with an optimal task complexity in terms of the set of semantic classes.

As discussed, during training, a reduced number of classifications relative to the full set of classifications may be used to train each intermediate stage of the neural network. In doing so, learning tasks may be customized for each stage in the neural network so that training is neither too complex nor too simple, both of which may lead to unoptimized inference performance (e.g., accuracy) for the neural network. In some aspects, some intermediate stages may be trained to perform classification tasks on very broad categories, while other (later) intermediate stages may be trained to perform classification tasks on narrower categories. For example, in an object detection system, an intermediate layer of the neural network might be trained to classify objects into either a stationary object or a moving object class, and later intermediate layers of the neural network may be trained to classify data more granularly. For example, for stationary objects, an intermediate layer may be trained to classify these objects as either living or non-living objects, a further intermediate layer may be trained to classify living objects into one of a plurality of species, and so on.

Generally, to allow for the final segmentation layer to use the hierarchy of features in generating an inference, various fusing techniques may be used to provide a set of semantic data to the last layer for use in segmentation. For example, for each intermediate layer, the segmentation features for that layer may be input into an Object Contextual Representation (OCR) block, which enhances the features via relational context attention. These enhanced intermediate features are then fused and provided to the final segmentation layer. To reduce computational cost with the task complexity, the number of channels defined for an intermediate OCR block may be set to a smaller number of channels than of the number of channels in the next stage we set the number of channels (e.g., ½ of the number of channels in the next stage).

### Example Methods for Classifying Data Using Neural Networks Trained Using Hierarchical Supervision

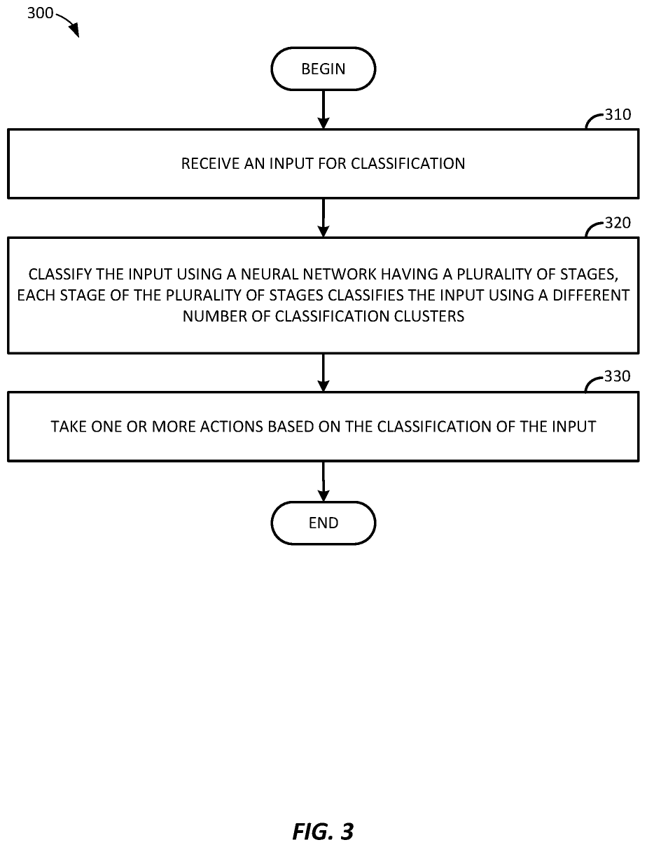

FIG. 3 illustrates example operations that may be performed by a computing device to classify data using a neural network trained using hierarchical supervision, according to certain aspects of the present disclosure. Operations 300 may be performed, for example, by a physical or virtual computing device or cluster of physical and/or virtual computing devices on which neural networks can be deployed and used to classify an input and take one or more actious based on the classification of the input.

As illustrated, operations 300 begin at block 310, where an input is received for classification. The input may include, for example, an image captured by one or more cameras or other imaging devices communicatively coupled with the computing device on which the neural network is deployed and executing. For example, the input may include domain-specific imaging data, such as images captured by a medical imaging device (e.g., X-ray machines, computed tomography machines, magnetic resonance imaging machines, etc.). In another example, the input may include information to be used in real-time decision making, such as camera or other imaging data from one or more imaging devices used by a vehicle user equipment (UE) operating autonomously or semi-autonomously.

At block 320, the input is classified using a neural network having a plurality of stages. Each stage of the plurality of stages generally classifies the input using a different number of classification clusters. For example, each stage of the plurality of stages downstream from the final stage (e.g., stages prior to a final stage of the neural network) in the neural network may be trained to generate an inference using a reduced number of classification clusters relative to a number of classification clusters used by the final stage. In some aspects, the stages may use a monotonically increasing number of classification clusters as a function of the stage number such that a first stage of the neural network classifies the input into x classification clusters, a second stage of the neural network classifies the input into y classification clusters, a third stage of the neural network classifies the input into z classification clusters, and so on, where x<y<z. The number of classification clusters used at each stage of the neural network may be defined a priori according to an equation defining the number of classification clusters as a function of the stage number or may be selected based on a cluster-validation set performance metric for the final stage of the neural network and the number of classification clusters used by the final stage and an angle selected for a line drawn from a point on a plot corresponding to the cluster-validation set performance metric for the final stage of the neural network.

At block 330, one or more actions are taken based on the classification of the input. Generally, the one or more actions may be associated with a specific application for which data is being classified. In a medical application, in which domain-specific imagery is classified using the neural network, the one or more actions may include identifying portions of an image, corresponding to areas in a human body, in which a disease is present. In an autonomous vehicle or semi-autonomous vehicle application, the one or more actions may include identifying a direction of travel and applying a steering input to cause the vehicle to travel in the identified direction, accelerating or decelerating the vehicle, or otherwise controlling the vehicle to avoid obstacles or harm to persons or property in the vicinity of the vehicle.

### Example Cluster-Validation Set Performance Metric Plot for Selecting a Number of Classification Clusters Used in Stages of a Neural Network

FIG. 4 illustrates an example plot 400 of cluster-validation set performance for each stage of a plurality of stages in a neural network as a function of a number of classification clusters in the neural network.

In particular, plot 400 includes first stage inference performance line 402, second stage inference performance line 404, and third stage inference performance line 406 for the different stages of a three-stage neural network. In plot 400, inference accuracy, represented on the vertical axis by a mean intersection over union (mIoU) measurement for each number of classification clusters from a defined minimum to a defined maximum number of classification clusters. Generally, inference accuracy increases as the number of classification clusters decreases (at the expense of the usefulness of any given inference, as broad classifications may be less useful than more granular classifications). The mIoU value for each stage of the neural network and each number of classification clusters generally represents an accuracy of classifications made by the neural network based on a ratio of true positives to the number of true positives, false negatives, and false negatives identified by the neural network.

To identify a number of classification clusters to use in retraining the intermediate stages of the neural network (e.g., stages other than an input stage and a final stage—in this example, Stage 3—of the neural network), inference performance of the final stage of the neural network for the maximum number of classification clusters into which data can be classified may be selected as origin point 410. An angle θ may be selected for drawing a line 420 in the plot 400 from the origin point 410, with an angle measured from the vertical axis to the horizontal axis. As discussed, when θ=0°, the neural network may be trained using direct supervision and the same number of classification clusters in each stage of the neural network. Meanwhile, when θ=90°, inference performance for each stage may converge to a value within a threshold amount from the performance of the final stage at the origin point 410.

Various techniques may be used to select the angle θ used in drawing line 420 from origin point 410. In some aspects, “greedy” techniques may be used to attempt to identify the angle resulting in the largest overall gain in inference performance between one or more of the intermediate stages of the neural network and the final stage of the neural network.

After angle θ is identified, and line 420 is drawn on plot 400, the number of classification clusters to use at each intermediate stage of the neural network may be identified. Generally, the number of classification clusters to use at any given intermediate stage of the neural network may be the number of classification clusters at the point where the inference performance line intersects with the line 420. As illustrated in FIG. 4, thus, the second stage of the neural network may be retrained to classify data into the number of clusters at point K2 430, and the first stage of the neural network may be retrained to classify data into the number of clusters at point K1 440. In this manner, hierarchical supervision of the neural network may be achieved by using smaller numbers of classification clusters in earlier stages of a neural network and increasing the number of classification clusters used in later stages of the neural network until the maximum number of classification clusters are used by the final stage of the neural network.

### Example Architectures for Neural Networks Trained Using Hierarchical Supervision

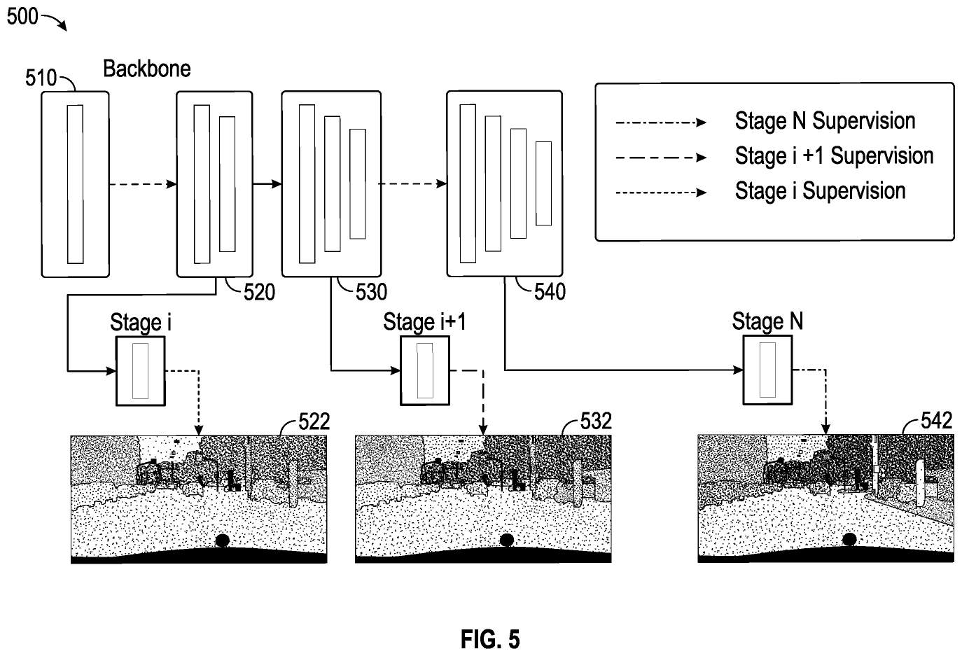

FIG. 5 illustrates an example architecture of a neural network 500 trained using hierarchical supervision, according to aspects of the present disclosure. Neural network 500 includes an input stage 510, a first intermediate stage 520, a second intermediate stage 530, and an output stage 540. Within each stage, as illustrated conceptually, an input from a prior stage may be further compressed into another representation, and the data generated by a prior stage may be an input into a current stage of the neural network.

Input stage 510 represents a stage of neural network 500 that is configured to receive an input of data to be classified through neural network 500. Input stage 510 generally dispatches the received input to a first intermediate stage 520, which generates first stage output 522 using a first number of classification clusters that is less than the number of classification clusters into which data can be classified at output stage 540 of the neural network 500. In the example illustrated herein, the input received at input stage 510 may be an image captured by an imaging device in an autonomous vehicle, and the first stage output 522 may include a classification of different pixels in the input image, representing different portions of the environment in which the autonomous vehicle is operating, into one of a plurality of object classifications (e.g., road, buildings, other vehicles, etc.)

The output of the first intermediate stage 520 may be input into second intermediate stage 530. Similar to first intermediate stage 520, second intermediate stage 530 may be configured to classify the data input from first intermediate stage 520 using a second number of classification clusters. The second number of classification clusters may be greater than the first number of classification clusters and may be less than the number of classification clusters into which data can be classified at output stage 540 of the neural network 500. For example, intermediate stage 520 may classify data using the number of classification clusters associated with point K1 440, while intermediate stage 530 may classify data using the number of classification clusters associated with point K2 430. In the example illustrated herein, the second stage output 532 also includes a classification of different pixels in the received image into one of a plurality of classes. Different representations of these pixels, such as different color values, generally represent different classifications into which data is classified. In this example, relative to output 522 in which all vehicles in the image are classified similarly, second intermediate stage 530 may be configured to recognize differences between different types of vehicles. Instead of classifying all vehicles in the image into the generic class of vehicles, second intermediate stage 530 can classify vehicles into a first category of four-wheeled vehicles and a second category of two-wheeled vehicles.

The output of second intermediate stage 530 may be provided as input into the output stage 540, which is configured to generate a final classification of data in the image and output the final classification 542 for use in identifying an action to perform based on the final classification. Output stage 540, as discussed, is generally trained to classify data into the number of classification clusters, which is larger than the number of classification clusters implemented at first intermediate stage 520 and second intermediate stage 530. In this example, further granular detail has been identified at output stage 540 such that different portions of a flat surface are delineated between road surfaces and non-road surfaces.

Each of first intermediate stage 520, second intermediate stage 530, and output stage 540 may be trained using supervised learning techniques. As discussed, the supervised learning techniques may be hierarchical, such that earlier stages in the neural network 500 are trained to classify data into fewer classification clusters than later stages in the neural network. By doing so, aspects of the present disclosure may improve the accuracy of the neural network 500 while taking into account the computational power available to perform inferences at any given stage of neural network 500.

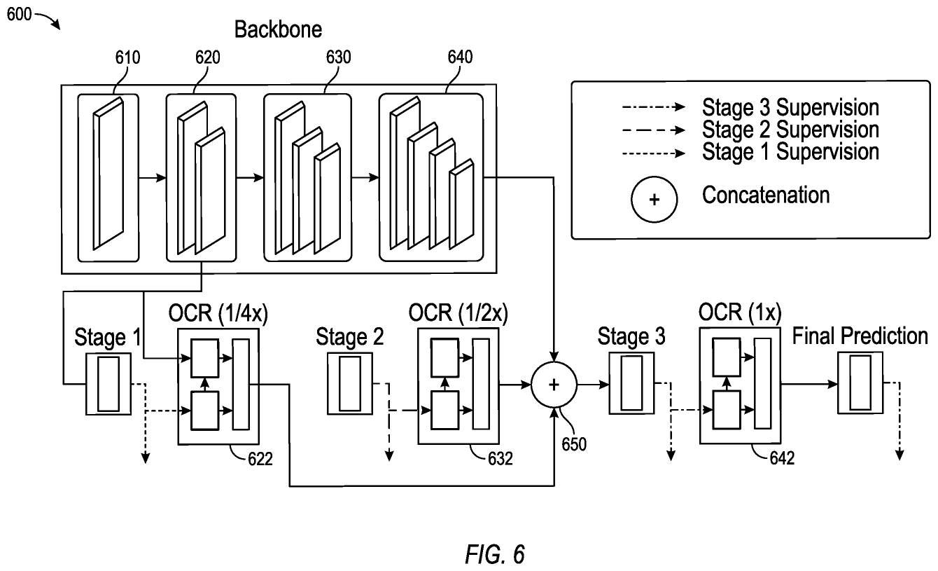

FIG. 6 illustrates an example architecture of a neural network 600 trained using hierarchical supervision in which the neural network includes segmentation transformers associated with each stage of the neural network, according to aspects of the present disclosure.

As illustrated, neural network 600 includes an input stage 610, a plurality of intermediate stages 620 and 630, and an output stage 640. Each intermediate stage 620 and 630 is associated with a respective segmentation transformer (or OCR module) 622 and 632, respectively, and output stage 640 may be associated with an output segmentation transformer 642. These segmentation transformers, as discussed, allow for a one-dimensional embedding to be extracted for each class.

As illustrated, each segmentation transformer 622, 632, and 642 may be configured to classify data into a number of classification clusters selected as a function of the stage of the neural network in which the segmentation transformers are deployed. For a neural network where the number of stages N=3, segmentation transformer 642 (associated with the final stage 640 of the neural network 600) may be trained to classify data into

$$\frac{1}{{2}^{3 - 3}} = \frac{1}{{2}^{0}} = 1 x$$

the total number of classification clusters. Intermediate stage 630, being the second stage in the neural network 600, may be trained to classify data into

$$\frac{1}{{2}^{3 - 2}} = \frac{1}{{2}^{1}} = \frac{1}{2} x$$

the total number of classification clusters. Finally, intermediate stage 620, being the first stage in the neural network 600, may be trained to classify data into

$$\frac{1}{{2}^{3 - 1}} = \frac{1}{{2}^{2}} = \frac{1}{4} x$$

the total number of classification clusters.

To provide additional information in training neural network 600, the outputs of the segmentation transformers associated with stages in the neural network 600 other than final stage 640 (e.g., as illustrated in FIG. 6, the outputs of segmentation transformers 622 and 632) may be concatenated at concatenator 650. That is, for an N stage neural network, the outputs of the segmentation transformers associated with stages 1 through N−1 of the neural network may be concatenated. The output of concatenator 650 may be input into the final stage 640 of the neural network (e.g., stage 3 of a neural network where N=3) to train the final stage. Concatenation of the outputs of the segmentation transformers may impose an additional processing overhead in training in generating inferences through the neural network 600, but may allow for additional information to be used in training and generating inferences using the neural network 600 and improve the accuracy of inferences generated by the neural network 600.

The performance of the neural networks trained using the techniques discussed herein generally result in increased inference performance relative to training multi-stage neural networks using direct supervision. For example, inference accuracy, measured by mean intersection over union (mIoU) is generally higher for neural networks trained using the hierarchical supervision techniques discussed herein than for neural networks trained using direct supervision techniques. In some aspects, various techniques (such as incorporating segmentation transformers into each stage of the neural network) may result in both increased inference accuracy and increased throughput (e.g., as measured in billions of multiply-and-accumulate operations (MACs)). The hierarchical supervision techniques discussed herein, when controlled for constant throughput (e.g., a similar number of MACs), may still result in increased inference accuracy for the same or similar computational cost.

### Example Processing Systems for Training Machine Learning Models Using Hierarchical Supervision

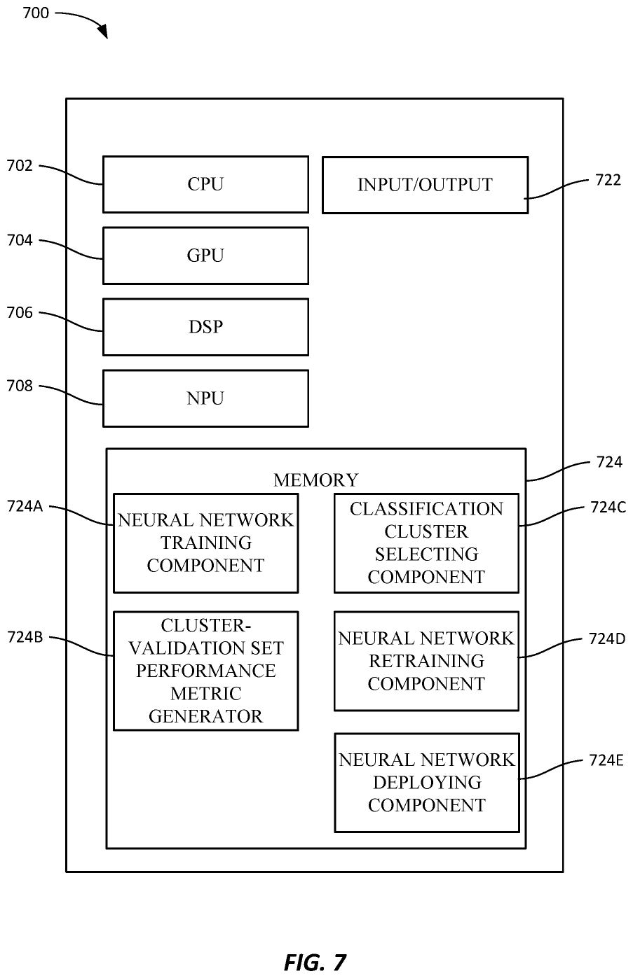

FIG. 7 depicts an example processing system 700 for training a neural network using hierarchical supervision, such as described herein for example with respect to FIG. 2.

Processing system 700 includes a central processing unit (CPU) 702, which in some examples may be a multi-core CPU. Instructions executed at the CPU 702 may be loaded, for example, from a program memory associated with the CPU 702 or may be loaded from a memory 724 or memory partition.

Processing system 700 also includes additional processing components tailored to specific functions, such as a graphics processing unit (GPU) 704, a digital signal processor (DSP) 706, a neural processing unit (NPU) 708, and a wireless connectivity component 712.

An NPU, such as 708, is generally a specialized circuit configured for implementing all the necessary control and arithmetic logic for executing machine learning algorithms, such as algorithms for processing artificial neural networks (ANNs), deep neural networks (DNNs), random forests (RFs), and the like. An NPU may sometimes alternatively be referred to as a neural signal processor (NSP), tensor processing units (TPU), neural network processor (NNP), intelligence processing unit (IPU), vision processing unit (VPU), or graph processing unit.

NPUs, such as 708, are configured to accelerate the performance of common machine learning tasks, such as image classification, machine translation, object detection, and various other predictive models. In some examples, a plurality of NPUs may be instantiated on a single chip, such as a system on a chip (SoC), while in other examples they may be part of a dedicated neural-network accelerator.

NPUs may be optimized for training or inference, or in some cases configured to balance performance between both. For NPUs that are capable of performing both training and inference, the two tasks may still generally be performed independently.

NPUs designed to accelerate training are generally configured to accelerate the optimization of new models, which is a highly compute-intensive operation that involves inputting an existing dataset (often labeled or tagged), iterating over the dataset, and then adjusting model parameters, such as weights and biases, in order to improve model performance. Generally, optimizing based on a wrong prediction involves propagating back through the layers of the model and determining gradients to reduce the prediction error.

NPUs designed to accelerate inference are generally configured to operate on complete models. Such NPUs may thus be configured to input a new piece of data and rapidly process it through an already trained model to generate a model output (e.g., an inference).

In one implementation, NPU 708 is a part of one or more of CPU 702, GPU 704, and/or DSP 706.

Processing system 700 may also include one or more input and/or output devices 722, such as screens, touch-sensitive surfaces (including touch-sensitive displays), physical buttons, speakers, microphones, and the like.

In some examples, one or more of the processors of processing system 700 may be based on an ARM or RISC-V instruction set.

Processing system 700 also includes memory 724, which is representative of one or more static and/or dynamic memories, such as a dynamic random access memory, a flash-based static memory, and the like. In this example, memory 724 includes computer-executable components, which may be executed by one or more of the aforementioned processors of processing system 700.

In particular, in this example, memory 724 includes neural network training component 724A, cluster-validation set performance metric generator component 724B, classification cluster selecting component 724C, neural network retraining component 724D, and neural network deploying component 724E. The depicted components, and others not depicted, may be configured to perform various aspects of the methods described herein.

Generally, processing system 700 and/or components thereof may be configured to perform the methods described herein. Notably, aspects of processing system 700 may be distributed.

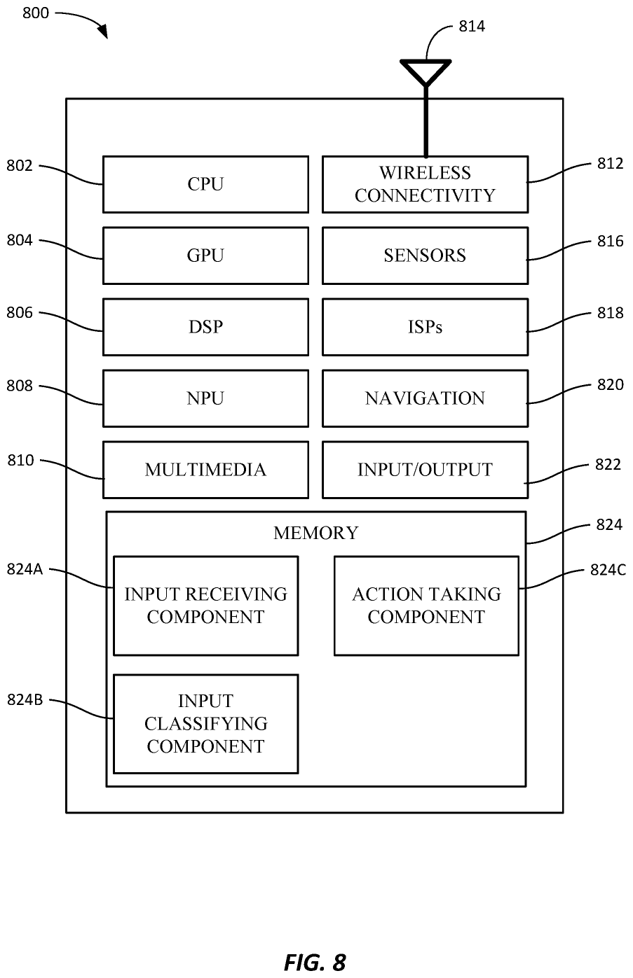

FIG. 8 depicts an example processing system 800 for classifying data using a multi-stage neural network trained using supervised learning techniques, such as described herein for example with respect to FIG. 3.

Processing system 800 includes a central processing unit (CPU) 802, which in some examples may be a multi-core CPU. Instructions executed at the CPU 802 may be loaded, for example, from a program memory associated with the CPU 802 or may be loaded from a memory 824 or memory partition.

Processing system 800 also includes additional processing components tailored to specific functions, such as a graphics processing unit (GPU) 804, a digital signal processor (DSP) 806, a neural processing unit (NPU) 808, a multimedia processing unit 810, a multimedia processing unit 810, and a wireless connectivity component 812.

An NPU, such as 808, is generally a specialized circuit configured for implementing all the necessary control and arithmetic logic for executing machine learning algorithms, such as algorithms for processing artificial neural networks (ANNs), deep neural networks (DNNs), random forests (RFs), and the like. An NPU may sometimes alternatively be referred to as a neural signal processor (NSP), tensor processing units (TPU), neural network processor (NNP), intelligence processing unit (IPU), vision processing unit (VPU), or graph processing unit.

NPUs, such as 808, may be configured similarly to NPU 708 described above with respect to FIG. 7. In one implementation, NPU 808 is a part of one or more of CPU 802, GPU 804, and/or DSP 806.

In some examples, wireless connectivity component 812 may include subcomponents, for example, for third generation (3G) connectivity, fourth generation (4G) connectivity (e.g., 4G LTE), fifth generation connectivity (e.g., 5G or NR), Wi-Fi connectivity, Bluetooth connectivity, and other wireless data transmission standards. Wireless connectivity component 812 is further connected to one or more antennas 814.

Processing system 800 may also include one or more sensor processing units 816 associated with any manner of sensor, one or more image signal processors (ISPs) 818 associated with any manner of image sensor, and/or a navigation processor 820, which may include satellite-based positioning system components (e.g., GPS or GLONASS) as well as inertial positioning system components.

Processing system 800 may also include one or more input and/or output devices 822, such as screens, touch-sensitive surfaces (including touch-sensitive displays), physical buttons, speakers, microphones, and the like.

In some examples, one or more of the processors of processing system 800 may be based on an ARM or RISC-V instruction set.

Processing system 800 also includes memory 824, which is representative of one or more static and/or dynamic memories, such as a dynamic random access memory, a flash-based static memory, and the like. In this example, memory 824 includes computer-executable components, which may be executed by one or more of the aforementioned processors of processing system 800.

In particular, in this example, memory 824 includes input receiving component 824A, input classifying component 824B, and action taking component 824C. The depicted components, and others not depicted, may be configured to perform various aspects of the methods described herein.

Generally, processing system 800 and/or components thereof may be configured to perform the methods described herein.

Notably, in other embodiments, aspects of processing system 800 may be omitted, such as where processing system 800 is a server computer or the like. For example, multimedia processing unit 810, wireless connectivity component 812, sensor processing units 816, ISPs 818, and/or navigation processor 820 may be omitted in other embodiments. Further, aspects of processing system 800 may be distributed, such as training a model and using the model to generate inferences.

### Example Clauses

Implementation details of various aspects of the present disclosure are described in the following numbered clauses.

Clause 1: A method, comprising: training a neural network with a plurality of stages using a training data set and an initial number of classification cluster into which data in the training data set can be classified; generating a cluster-validation set performance metric for each stage of the plurality of stages of the neural network based on a reduced number of classification clusters relative to the initial number of classification clusters and a validation data set separate from the training data set; selecting a number of classification clusters to implement at each stage of the plurality of stages of the neural network based on the cluster-validation set performance metric and an angle selected relative to the cluster-validation set performance metric for a last stage of the neural network; retraining the neural network based on the training data set and the selected number of classification clusters for each stage of the plurality of stages; and deploying the trained neural network.

Clause 2: The method of Clause 1, further comprising, for each stage of the plurality of stages: calculating a confusion matrix for the training data set and a confusion matrix for the validation data set, wherein discrete elements in one dimension of the confusion matrices represent one of a plurality of classification clusters; calculating an adjacency matrix based on the confusion matrix calculated for the training data set and the confusion matrix calculated for the validation data set; and generating the reduced number of classification clusters using agglomerative clustering of neighboring clusters in the calculated adjacency matrix such that a plurality of neighboring clusters are reduced into a single cluster representing a broader classification of data than each of the plurality of neighboring clusters.

Clause 3: The method of any one of Clauses 1 or 2, wherein generating the cluster-validation set performance metric comprises calculating a performance metric for each stage in the plurality of stages for cluster sizes up to and including the initial number of classification clusters.

Clause 4: The method of Clause 3, wherein the performance metric comprises a mean intersection over union (mIoU) metric calculated as a function of a number of clusters in each stage of the plurality of stages in the neural network.

Clause 5: The method of any one of Clauses 1 through 4, wherein: the selected angle comprises a zero degree angle, and training the neural network based on the training data set and the selected number of classification clusters at each stage comprises training the plurality of stages in the neural network using direct supervision.

Clause 6: The method of any one of Clauses 1 through 4, wherein: the selected angle comprises a ninety degree angle, and training the neural network based on the training data set and the selected number of classification clusters at each stage comprises training the plurality of stages in the neural network such that performance of each stage of the neural network converges to a performance level within a threshold value.

Clause 7: The method of any one of Clauses 1 through 6, wherein retraining the neural network based on the training data set and the selected number of classification clusters at each stage comprises minimizing a total loss function, wherein: the total loss function comprises a sum of a loss function for each respective stage of the plurality of stages weighted by a value associated with each respective stage of the plurality of stages, and the loss function for the respective stage of the plurality of stages is based on a number of classification clusters selected for the respective stage.

Clause 8: The method of any one of Clauses 1 through 7, wherein retraining the neural network based on the training data set and the selected number of classification clusters at each stage comprises: aggregating an output of each stage of the plurality of stages other than a final stage of the neural network; and training the final stage of the neural network based on an input of the aggregated output of the plurality of stages other than the final stage of the neural network into a segmentation transformer module associated with the final stage of the neural network.

Clause 9: A method, comprising: receiving an input for classification; classifying the input using a neural network having a plurality of stages, wherein each stage of the plurality of stages classifies the input using a different number of classification clusters; and taking one or more actions based on the classification of the input.

Clause 10: The method of Clause 9, wherein classifying the output comprises classifying the input at a stage of the plurality of stages based on an inference generated by a prior stage of the plurality of stages.

Clause 11: The method of any one of Clauses 9 or 10, wherein: the neural network comprises a neural network including segmentation transformers at each stage of the neural network, output of each stage of the neural network other than the final stage of the neural network is aggregated, and the aggregated output is input into a segmentation transformer associated with a final stage of the neural network to generate the classification of the input.

Clause 12: The method of any one of Clauses 9 through 11, wherein each stage of the plurality of stages classifies the input using a larger number of classification clusters than a preceding stage of the plurality of stages.

Clause 13: An apparatus, comprising: a memory having executable instructions stored thereon; and a processor configured to execute the executable instructions to cause the apparatus to perform a method in accordance with of any one of Clauses 1 through 12.

Clause 14: An apparatus, comprising: means for performing a method in accordance with of any one of Clauses 1 through 12.

Clause 15: A non-transitory computer-readable medium having instructions stored thereon which, when executed by a processor, performs a method in accordance with of any one of Clauses 1 through 12.

Clause 16: A computer program product embodied on a computer-readable storage medium comprising code for performing a method in accordance with of any one of Clauses 1 through 12.

### ADDITIONAL CONSIDERATIONS

The preceding description is provided to enable any person skilled in the art to practice the various embodiments described herein. The examples discussed herein are not limiting of the scope, applicability, or embodiments set forth in the claims. Various modifications to these embodiments will be readily apparent to those skilled in the art, and the generic principles defined herein may be applied to other embodiments. For example, changes may be made in the function and arrangement of elements discussed without departing from the scope of the disclosure. Various examples may omit, substitute, or add various procedures or components as appropriate. For instance, the methods described may be performed in an order different from that described, and various steps may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

As used herein, the word “exemplary” means “serving as an example, instance, or illustration.” Any aspect described herein as “exemplary” is not necessarily to be construed as preferred or advantageous over other aspects.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like.

The methods disclosed herein comprise one or more steps or actions for achieving the methods. The method steps and/or actions may be interchanged with one another without departing from the scope of the claims. In other words, unless a specific order of steps or actions is specified, the order and/or use of specific steps and/or actions may be modified without departing from the scope of the claims. Further, the various operations of methods described above may be performed by any suitable means capable of performing the corresponding functions. The means may include various hardware and/or software component(s) and/or module(s), including, but not limited to a circuit, an application specific integrated circuit (ASIC), or processor. Generally, where there are operations illustrated in figures, those operations may have corresponding counterpart means-plus-function components with similar numbering.

The following claims are not intended to be limited to the embodiments shown herein, but are to be accorded the full scope consistent with the language of the claims. Within a claim, reference to an element in the singular is not intended to mean “one and only one” unless specifically so stated, but rather “one or more.” Unless specifically stated otherwise, the term “some” refers to one or more. No claim element is to be construed under the provisions of 35 U.S.C. § 112(f) unless the element is expressly recited using the phrase “means for” or, in the case of a method claim, the element is recited using the phrase “step for.” All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims.

What is claimed is:

1. A computer-implemented method for generating an inference using a machine learning model, comprising:
receiving an input for classification;
classifying the input using a neural network having a plurality of stages, wherein each stage of the plurality of stages classifies the input using a different number of classification clusters; and
taking one or more actions based on the classification of the input.

2. The method of claim 1, wherein classifying the output comprises classifying the input at a stage of the plurality of stages based on an inference generated by a prior stage of the plurality of stages.

3. The method of claim 1, wherein:
the neural network comprises a neural network including segmentation transformers at each stage of the neural network,
output of each stage of the neural network other than a final stage of the neural network is aggregated, and
the aggregated output is input into a segmentation transformer associated with the final stage of the neural network to generate the classification of the input.

4. The method of claim 1, wherein each stage of the plurality of stages classifies the input using a larger number of classification clusters than a preceding stage of the plurality of stages.

5. A computer-implemented method for training a machine learning model, comprising:
training a neural network with a plurality of stages using a training data set and an initial number of classification cluster into which data in the training data set can be classified;
generating a cluster-validation set performance metric for each stage of the plurality of stages of the neural network based on a reduced number of classification clusters relative to the initial number of classification clusters and a validation data set separate from the training data set;
selecting a number of classification clusters to implement at each stage of the plurality of stages of the neural network based on the cluster-validation set performance metric and an angle selected relative to the cluster-validation set performance metric for a last stage of the neural network;
retraining the neural network based on the training data set and the selected number of classification clusters for each stage of the plurality of stages; and
deploying the trained neural network.

6. The method of claim 5, further comprising, for each stage of the plurality of stages:
calculating a confusion matrix for the training data set and a confusion matrix for the validation data set, wherein discrete elements in one dimension of the confusion matrices represent one of a plurality of classification clusters;
calculating an adjacency matrix based on the confusion matrix calculated for the training data set and the confusion matrix calculated for the validation data set; and
generating the reduced number of classification clusters using agglomerative clustering of neighboring clusters in the calculated adjacency matrix such that a plurality of neighboring clusters are reduced into a single cluster representing a broader classification of data than each of the plurality of neighboring clusters.

7. The method of claim 5, wherein generating the cluster-validation set performance metric comprises calculating a performance metric for each stage in the plurality of stages for cluster sizes up to and including the initial number of classification clusters.

8. The method of claim 7, wherein the performance metric comprises a mean intersection over union (mIoU) metric calculated as a function of a number of clusters in each stage of the plurality of stages in the neural network.

9. The method of claim 5, wherein:
the selected angle comprises a zero degree angle, and
training the neural network based on the training data set and the selected number of classification clusters at each stage comprises training the plurality of stages in the neural network using direct supervision.

10. The method of claim 5, wherein:
the selected angle comprises a ninety degree angle, and
training the neural network based on the training data set and the selected number of classification clusters at each stage comprises training the plurality of stages in the neural network such that performance of each stage of the neural network converges to a performance level within a threshold value.

11. The method of claim 5, wherein retraining the neural network based on the training data set and the selected number of classification clusters at each stage comprises minimizing a total loss function, wherein:
the total loss function comprises a sum of a loss function for each respective stage of the plurality of stages weighted by a value associated with each respective stage of the plurality of stages, and
the loss function for the respective stage of the plurality of stages is based on a number of classification clusters selected for the respective stage.

12. The method of claim 5, wherein retraining the neural network based on the training data set and the selected number of classification clusters at each stage comprises:
aggregating an output of each stage of the plurality of stages other than a final stage of the neural network; and
training the final stage of the neural network based on an input of the aggregated output of the plurality of stages other than the final stage of the neural network into a segmentation transformer module associated with the final stage of the neural network.

13. A processing system, comprising:
a memory having computer-executable instructions stored thereon; and
a processor configured to execute the computer-executable instructions to cause the processing system to:
receive an input for classification;
classify the input using a neural network having a plurality of stages, wherein each stage of the plurality of stages classifies the input using a different number of classification clusters; and
take one or more actions based on the classification of the input.

14. The processing system of claim 13, wherein in order to classify the output, the processor is configured to cause the processing system to classify the input at a stage of the plurality of stages based on an inference generated by a prior stage of the plurality of stages.

15. The processing system of claim 13, wherein:
the neural network comprises a neural network including segmentation transformers at each stage of the neural network,
output of each stage of the neural network other than a final stage of the neural network is aggregated, and
the aggregated output is input into a segmentation transformer associated with the final stage of the neural network to generate the classification of the input.

16. The processing system of claim 13, wherein each stage of the plurality of stages classifies the input using a larger number of classification clusters than a preceding stage of the plurality of stages.

17. A processing system, comprising:
a memory having computer-executable instructions stored thereon; and
a processor configured to execute the computer-executable instructions to cause the processing system to:
train a neural network with a plurality of stages using a training data set and an initial number of classification cluster into which data in the training data set can be classified;
generate a cluster-validation set performance metric for each stage of the plurality of stages of the neural network based on a reduced number of classification clusters relative to the initial number of classification clusters and a validation data set separate from the training data set;
select a number of classification clusters to implement at each stage of the plurality of stages of the neural network based on the cluster-validation set performance metric and an angle selected relative to the cluster-validation set performance metric for a last stage of the neural network;
retrain the neural network based on the training data set and the selected number of classification clusters for each stage of the plurality of stages; and
deploy the trained neural network.

18. The processing system of claim 17, wherein the processor is further configured to cause the processing system to:
calculate a confusion matrix for the training data set and a confusion matrix for the validation data set, wherein discrete elements in one dimension of the confusion matrices represent one of a plurality of classification clusters;
calculate an adjacency matrix based on the confusion matrix calculated for the training data set and the confusion matrix calculated for the validation data set; and
generate the reduced number of classification clusters using agglomerative clustering of neighboring clusters in the calculated adjacency matrix such that a plurality of neighboring clusters are reduced into a single cluster representing a broader classification of data than each of the plurality of neighboring clusters.

19. The processing system of claim 17, wherein in order to generate the cluster-validation set performance metric, the processor is configured to cause the processing system to calculate a performance metric for each stage in the plurality of stages for cluster sizes up to and including the initial number of classification clusters.

20. The processing system of claim 19, wherein the performance metric comprises a mean intersection over union (mIoU) metric calculated as a function of a number of clusters in each stage of the plurality of stages in the neural network.

21. The processing system of claim 17, wherein:
the selected angle comprises a zero degree angle, and
in order to train the neural network based on the training data set and the selected number of classification clusters at each stage, the processor is configured to cause the processing system to train the plurality of stages in the neural network using direct supervision.

22. The processing system of claim 17, wherein:
the selected angle comprises a ninety degree angle, and
in order to train the neural network based on the training data set and the selected number of classification clusters at each stage, the processor is configured to cause the processing system to train the plurality of stages in the neural network such that performance of each stage of the neural network converges to a performance level within a threshold value.

23. The processing system of claim 17, wherein in order to retrain the neural network based on the training data set and the selected number of classification clusters at each stage, the processor is configured to cause the processing system to minimize a total loss function, wherein:
the total loss function comprises a sum of a loss function for each respective stage of the plurality of stages weighted by a value associated with each respective stage of the plurality of stages, and
the loss function for the respective stage of the plurality of stages is based on a number of classification clusters selected for the respective stage.

24. The processing system of claim 17, wherein in order to retrain the neural network based on the training data set and the selected number of classification clusters at each stage, the processor is configured to cause the processing system to:
aggregate an output of each stage of the plurality of stages other than a final stage of the neural network; and
train the final stage of the neural network based on an input of the aggregated output of the plurality of stages other than the final stage of the neural network into a segmentation transformer module associated with the final stage of the neural network.
